(19) United States
(12) Patent Application Publication
(10) Pub. No.: US 2008/0243571 A1
(43) Pub. Date: Oct. 2, 2008

(54) AUDITING ADVERTISEMENT PRESENTATIONS ON A CLIENT DEVICE

(76) Inventor: Benjamin G. Edelman, Cambridge, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/058,019

(22) Filed: Mar. 28, 2008

Related U.S. Application Data
(60) Provisional application No. 60/909,610, filed on Apr. 2, 2007.

(51) Int. Cl. G06Q 30/00

(52) U.S. Cl. 705/7

(57) ABSTRACT

An advertisement auditing system determines whether advertisements are being presented to or displayed on client devices in an intended fashion. By comparing expected advertising results with actual advertising results on a client device, it is possible to evaluate the accuracy of advertising campaigns and advertisement content delivery. In various embodiments, the client device(s) may be virtualized to improve flexibility and scalability of auditing functions.

### RELATED APPLICATIONS

This application claims the benefit of U.S. Prov. App. No. 60/909,610 filed on Apr. 2, 2007, the entire content of which is hereby incorporated by reference.

### BACKGROUND

1. Field

This invention relates to the field of advertising, and more particularly to auditing advertisements presented on a client device.

2. Description of the Related Art

As Internet advertising becomes more complex, online advertisers face increasing challenges in monitoring where and how their ads are displayed. Traditionally, advertisers audit their ad placements by reviewing lists of sites on which they intended to advertise—that is, by examining what ads placements their ad servers are designed to send out, and perhaps by examining what advertisements have actually been requested or transmitted from an ad server. But such evaluation cannot uncover ad placements that are unintended or that are incorrectly recorded in advertisers' site lists, and in any event, do not guarantee the display of particular advertisements on a client device. As disclosed herein, complex online advertising relationships can better be audited from the other perspective—by examining what ads a client device, such as a user's computer, actually receives

There remains a need for online advertisement auditing based upon the receipt and display of advertisements on client devices.

### SUMMARY

An advertisement auditing system determines whether advertisements are being presented to or displayed on client devices in an intended fashion. By comparing expected advertising results with actual advertising results on a client device, it is possible to evaluate the accuracy of advertising campaigns and advertisement content delivery. In various embodiments, the client device(s) may be virtualized to improve flexibility and scalability of auditing functions.

In one aspect, an advertisement auditing system described herein includes a network connecting to a plurality of advertising sources including at least one advertisement; a client coupled to the network; a controller that controls operation of the client to issue a request for the advertisement; a monitor that monitors network activity of the client and compares the advertisement to an expected advertisement, thereby providing an audit result.

The system may include a memory for storing the audit result. The system may include at least one advertising software program executing on the client. The advertising software program may include one or more of spyware and adware. The plurality of advertising sources may include at least one ad server. The client may be a virtual client maintained in a virtualization environment. The system may include a plurality of virtual clients in the virtualization environment, each of the plurality of virtual clients controlled by the controller. The client may be a physical device. The controller may be external to the client, the client including an agent for remote operation of the client by the controller. The controller may be adapted to prepare a report of audit results. The controller may transmit the report to a designated recipient by electronic mail. The controller may be adapted to capture screen shot information with audit results.

In another aspect, a method disclosed herein includes operating a virtual client in a virtualization environment, wherein operating the network client includes directing the virtual client to engage in one or more interactions with a data network for which an expected advertisement should be transmitted to the virtual client; identifying an advertisement actually received by the network client in response to the one or more interactions; and comparing the advertisement with the expected advertisement to obtain an audit result.

The method may include operating a plurality of virtual clients in the virtualization environment. The method may include repeatedly directing the virtual client through one or more test scenarios to provide continuous audit results. The method may include executing at least one of a spyware program and an adware program on the virtual client.

In another aspect, a method disclosed herein includes operating a virtual client in a virtualization environment, wherein operating the virtual client includes directing the virtual client to engage in one or more interactions with a data network for which an expected advertisement should be displayed on the virtual client; identifying an advertisement actually displayed on the virtual client in response to the one or more interactions; and comparing the advertisement with the expected advertisement to obtain an audit result.

The method may include operating a plurality of virtual clients in the virtualization environment. The method may include repeatedly directing the virtual client through one or more test scenarios to provide continuous audit results. The method may include directing the virtual client to engage in one or more interactions with the data network for which a second expected advertisement should be transmitted to the virtual client; identifying a second advertisement actually received by the network client in response to the one or more interactions; and comparing the second advertisement with the second expected advertisement to obtain a second audit result.

### BRIEF DESCRIPTION OF THE DRAWINGS

The systems and methods described herein may be understood by reference to the following figures:

FIG. 1 shows a system for auditing advertisements on a client device.

FIG. 2 shows a method for operating an advertisement auditing system on a virtual client.

FIG. 3 shows a user interface for monitoring progress of an advertisement audit.

### DETAILED DESCRIPTION

In the systems and methods described herein, a client device may be executed on a virtual machine within a test environment. The client device may be operated to engage in one or more network interactions such as navigating across or within a number of web pages. During this time, advertisements delivered to or displayed by the client device may be compared to expected advertisements that are anticipated based upon the client device's requests and based upon observed network interactions. In this manner an audit of advertisement display behavior for a client device may be prepared and analyzed for use by advertisers, web site operators, consumers, and/or others who might be interested in whether particular advertisements, ad campaigns, and/or advertising policies promulgated across a network are being accurately realized on end user devices. For example, an advertiser may operate multiple virtual clients to visit websites where the advertiser's ad content is supposed to be displayed in order to determine whether the desired content is correctly reaching intended viewers. As another example, an advertiser may operate multiple virtual clients having different software or hardware configurations. As another example, an advertiser may operate multiple virtual clients, each with a different spyware or adware program, to make sure the advertiser's ads are not appearing through any of those programs or are being omitted because of those programs.

It will be understood that the term advertisement as used herein is intended to refer to any form of advertisement suitable for use in a network environment including text, graphics, audio, video, and combinations of these, as well as any other suitable multi-media and/or interactive media that may be independently rendered on a client device or rendered within a web page, video, streaming video, or the like that is viewed on a client device. It should further be understood that references herein to display of advertisements may refer to actual rendering on a client device, and/or may refer to virtual rendering within a virtual machine in a form that, while not humanly viewable, may be monitored for content by appropriate auditing and analysis software. The term advertisement may also, or instead, refer to a relationship or affiliation through which an advertisement is provided. Thus in general, an advertisement audit system as described herein may audit advertisements themselves and/or the relationship or channels through which advertisements are delivered.

It will also be appreciated that, while the foregoing detailed description focuses on evaluation of advertisement content, the principles of the invention may be similarly applied to any content requested from, received by, and/or rendered on a client device, in a complex, heterogeneous network environment. Thus the principles of the invention may be adapted to evaluation of web services, single player or multiplayer network games, entertainment or education multimedia, and so forth.

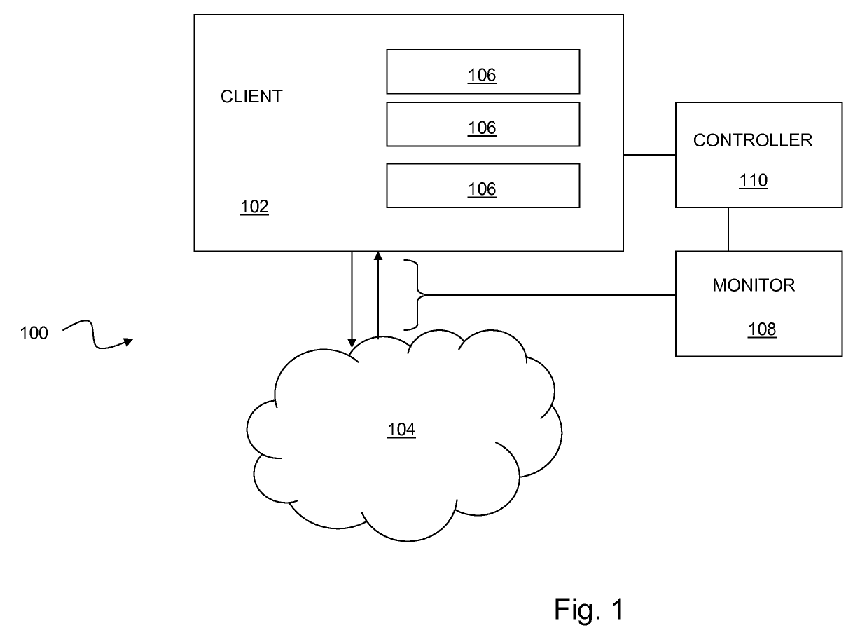

FIG. 1 shows a system for auditing advertisements on a client device. As shown, the system 100 may include one or more client devices 102 (also referred to herein simply as “clients”) connected to a network 104. The client 102 may be executing one or more programs 106, and an advertisement auditor 108 may monitor communications and behavior of the client 102 during operations.

The client device 102 may be any network client including without limitation a desktop computer, laptop computer, palmtop computer, cellular phone, wireless electronic mail device, or any other device that can connect to and communicate using a network such as the network 104. In certain embodiments described below, the client device 102 is a virtual client executing on any suitable platform. Where a virtual client is employed, the client may emulate the behavior of software and/or hardware of any suitable client device, and may be deployed on any suitable virtualization platform. In an embodiment, a primary computer system runs a software program (which may be the controller 110 described below) that interoperates with one or more virtual clients installed within the primary computer, as well as with a network monitor installed on the primary computer. The controller 110 may orchestrate auditing functions, such as by switching to a virtual computer, performing a test scenario or sequence of scenarios, and checking network monitor logs to determine what advertisements have been received by the virtual client. Thus a number of clients may be simultaneously tested as described below on a single hardware device. The virtual clients may, for example, be virtual machines within a VMware Workstation virtualization environment. In such an environment, each virtual client may have its own virtual hard disk, and may include, for example various combinations of operating systems, applications, spyware, adware, malware, and so forth. All of the above systems and combinations thereof are intended to fall within the scope of the term “client” as used herein.

The network 104 may be any data network, or combination of networks useful for supporting communications between the client 102 and remote content. In one typical embodiment, the network 104 is the Internet; however the network 104 may also, or instead, be a local area network, a wireless data network, a telecommunications network or any other private or public network, or any combination of the foregoing. Although not depicted, it will be understood that the network 104 may be coupled in a communicating relationship with various servers, content providers, and the like including, for example, web sites, advertisement servers, and other network entities described herein. In general, the network provides access by the client to a variety of advertisements and advertisement sources.

The programs 106 may include any software executing, or capable of being executed, on the client 102. This includes, without limitation, an operating system, application programs such as a web browser, communications software, and so forth. Advertisement media described herein may be rendered using plug-ins within the web browser, or using other media rendering programs associated with such a web browser or more generally with the client 102. In addition, the programs 106 may include desired or undesired advertisement programs such as adware, spyware, malware, ad-supported freeware, or the like, any of which may affect the manner in which advertisements sent to the client 102 over the network 104 are rendered (or not rendered) at the client 102.

An advertisement auditor 108 (also referred to herein as a “monitor”) may be provided to monitor requests from the client 102 and responses to the client 102 over the network 104. The advertisement auditor 108 may, in particular, compare actual advertising content provided to the client 102 against expected advertising content. In one embodiment, the advertisement auditor 108 compares actual network traffic against predicted network traffic in a configuration such as that depicted in FIG. 1, however it will be appreciated that numerous variations are possible. For example, the advertisement auditor 108 may monitor output to a display device (not shown) of the client 102 to determine whether expected advertisements are actually being displayed. This approach advantageously permits the system 100 to monitor local behavior of adware or spyware programs that might interfere with intended advertising content, such as by overriding or replacing content received over the network 104. Thus the advertisement auditor 108 may be another program 106 executing on the client 102 rather than an external resource. In still another embodiment, the client 102 and the advertisement auditor 108 may be executing on a single device within a virtualization environment such as that described above. All such variations, as well as any other modifications apparent to one of ordinary skill in the art and useful for tracking received advertising content and/or displayed advertising content at a client device may be suitably employed, and are intended to fall within the scope of this disclosure.

In an embodiment, the advertising auditor 108 is deployed as a Tamos CommView software program. In an embodiment, the advertising auditor 108 includes a memory for storing audit results, such as results of various specific comparisons of requested advertisements to expected advertisements. Although this memory is not depicted, it will be understood that the memory may be a non-volatile memory such as a disk drive, which stores test results on a continuing basis for later analysis. The memory may be separate from the client 102, or may be a memory device within the client 102.

A controller 110 may orchestrate operation of the client device 102 and the monitor 108 in order to exercise the system 100 over a range of network sites, application programs 106, and the like. During these tests, the controller 110 may cause the advertisement auditor 108 to record all network communications to a file on disk for analysis and, if desired, for further manual review. The controller 110 may also provide a user interface for reviewing, analyzing, and creating reports for the results. It will be appreciated that, while the controller 110 may be external to the client 102 as depicted in FIG. 1, the controller 110 may also, or instead, be a program 106 executing on the client 102, or, where the client 102 is a stand-alone physical device, may communicate with a controller agent installed on the client 102 and permitting remote control thereof. Numerous techniques for remote operation of a computer are known in the art, and may be suitable adapted to various deployments of the system 100 described herein.

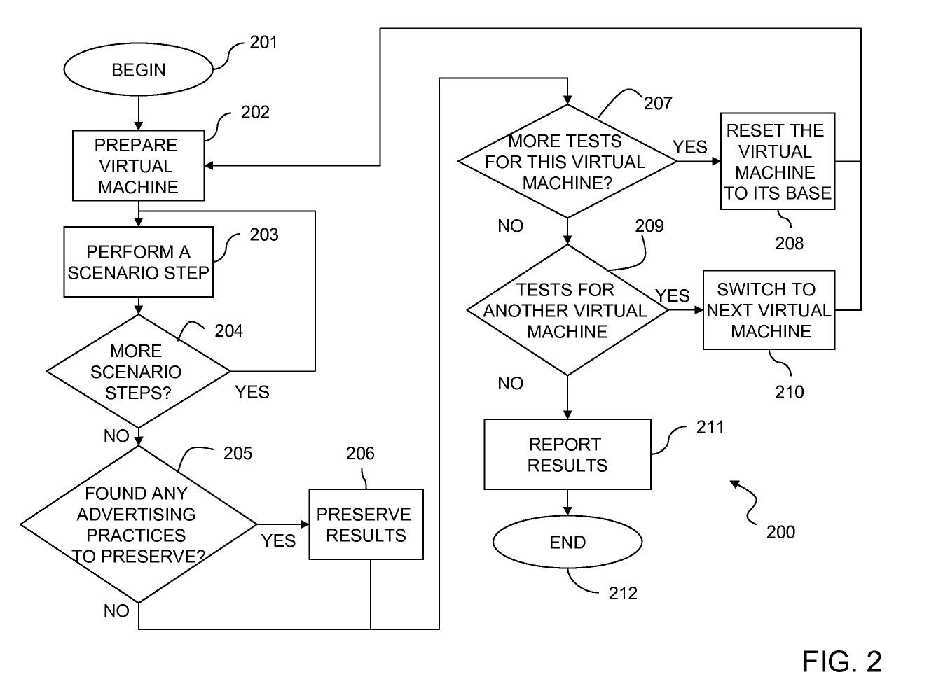

FIG. 2 illustrates a process for automated testing of advertisements. The process 200 may, for example be performed on any of the client devices described above with reference to FIG. 1, all under control of a controller such as the controller 110 described above.

The process 200 may begin 201 by preparing a virtual machine, such as the virtual client(s) described above, as shown in step 202.

As shown in step 203, the process may perform a scenario step, and then conditionally repeat the same step or other steps as shown in step 204 until there are no further scenario steps. Scenario steps may include, for example, any of the testing methods described herein, or any other client activity for which testing of resulting advertisements is desired. It will be understood that, while requesting content from a server is one useful form of testing for a scenario step, the process 200 may also, or instead, test local client activity through which locally executing client software may display or be intended to display advertisements.

In general, testing may include any feasible comparison between the expected advertisements and the actual or observed advertisements. This may include, for example, observation of a client on-screen display, network communications, and so forth.

By way of example and not of limitation, the controller may command the client device to request a web page on which an advertiser has contracted to receive a permanent advertisement placement. The process 200 may test whether the corresponding advertisement is actually received by the client, and/or whether the corresponding advertisement is actually displayed by the client. Where the corresponding advertisement is not received or displayed, the process 200 may log or report that result, such as by recording an unexpected omission of an anticipated advertisement. Similarly, the controller may command the client to directly visit a web site using a client device that is executing one or more spyware or adware programs. Because the controller initiated a direct visit to the specified web site, the expected result may be that the client device will reach that web site directly, not via any advertising link to that web site. If the client arrives at that web site through an advertising link, i.e. a link that requires the web site to pay a commission or a fee to an advertising partner, this result may be reported as an unexpected presence of an advertising link when no such link was requested. More generally, any number of tests may be devised for comparing actual to expected results for advertising relationships and/or content.

The system may interact with any number of supporting systems to create tests and evaluate results. For example, the system may interact with an advertisement billing system, either to determine what tests to perform or to report errors for which billing corrections are appropriate. The system may interact with various other advertisement tracking systems.

As shown in step 205, the process may determine whether there are any advertising practices to preserve. If there are such practices, then the process 200 may preserve the results of such tests as shown in step 206. This may include, for example, logging of advertisements served to the client, logging of actual media displayed by the client, and any other practices suitable for storage and subsequent use with the systems described herein.

As shown in step 207, the process 200 may evaluate whether there are more tests for a virtual machine, and if appropriate, may reset the virtual machine for additional testing as shown in step 208.

If there are no more tests for this virtual machine, the process 200 may check whether there are tests for another virtual machine as shown in step 209, and if so may switch to that virtual machine as shown in step 210 and commence testing. Finally, results may be reported as shown in step 211 and the process 200 may end 212. A variety of reporting mechanisms may be employed. For example, the controller may prepare a report of audit results in text, chart, table, XML or other format suitable for electronic or paper distribution. In one aspect, the controller may transmit the report by electronic mail to one or more recipients. This may include, for example, different reports for different advertisers, or different reports for different personnel (e.g., financial, information technology, legal, etc.). Reports may be sorted and transmitted according to advertising partners or the like. Furthermore, results of testing may initiate additional action, either by providing instructions to human participants or by directly interfacing with external computer systems. For example, the test results may interact with external systems to enable or disable accounts of advertising partners.

Throughout the above testing process, various results may be logged for retrieval and analysis. For example, the system may capture screen shot information with audit results, such as for specific instances of incorrect ad displays, or video records of a specific interaction that includes an incorrect advertisement result. Screen or video captures may be triggered, for example, by audit flags such as incorrect advertisements, unexpected referrals, or the like. Results may be stored in a single log file, or in numerous log files according to different customers, advertising partners, or the like. Similarly, numerous reports may be separately created and stored including raw log data as well as synthesized test results in more convenient, human-readable form. Similarly, raw network transmission data may be logged in any suitable format and archived for subsequent verification, analysis, and the like. In one aspect, all test results may be preserved. In another aspect, only certain results may be preserved, such as audit flags of unexpected or incorrect advertisement results. In one aspect, repeated flags may be omitted, or repeat flags may trigger a notification to a particular individual or computer system.

It will be appreciated that, while a single process flow is depicted, testing may in general be conducted concurrently, iteratively, or in various combinations using any number of physically or logically separate devices. Further, each test may include various steps, substeps, conditional steps, branches, and so forth. For example, a test may check for the presence of interactive advertising content, and interact with such content to confirm expected behavior. All such variations are intended to fall within the scope of a testing process as described herein.

It will further be appreciated that various iterative or random techniques may be employed for continuous testing of advertisements. For example, a particular test scenario may be continuously repeated to ensure ongoing integrity of a particular advertisement or ad campaign. Similarly, a test scenario may be randomly or deterministically altered to provide variation in testing over a series of tests.

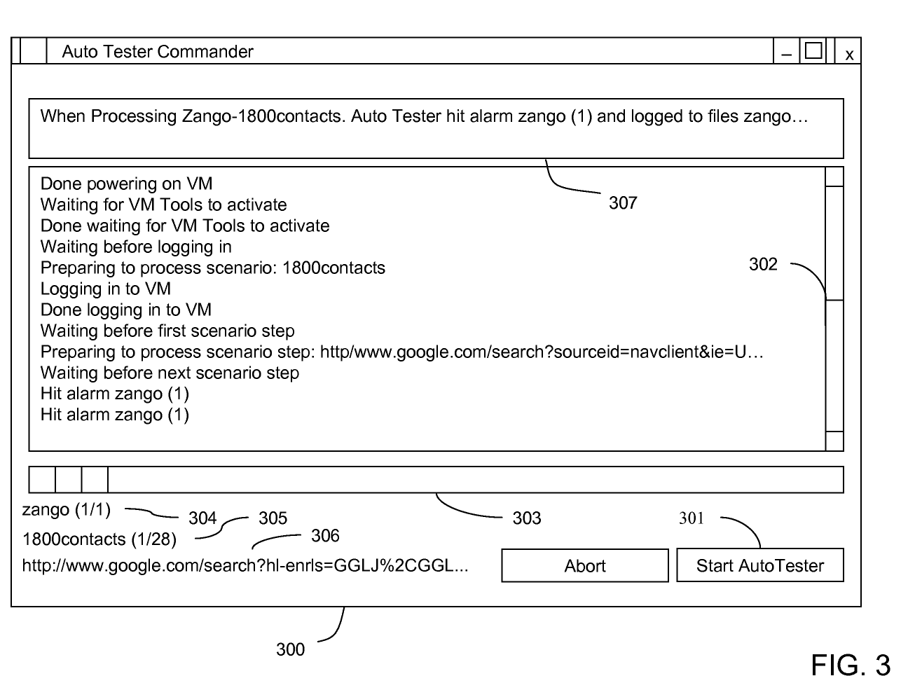

FIG. 3 shows a user interface for monitoring progress of an advertisement audit, which may, for example, be an advertisement audit executing on a virtual client as described generally above. In a user interface, an operator may press a Start AutoTester button 301. A primary log window 302 may then report the steps performed in any current testing initiated by the button 301. A status bar 303 may graphically depict the proportion of tests that have been completed, while a virtual machine status bar 304, a scenario status bar 305, and a scenario step status bar 306 report progress through the respective stages of testing. A findings log 307 may report the results of tests. It will be understood that the interface depicted in FIG. 3 is an example display only, and that numerous variations and additions are possible. For example, user controls may include pause, skip, and other incremental step controls for a current test, as well as commands for controlling multiple tests simultaneously or establishing testing parameters, reporting format, and so forth. Similarly, test status and test results may be displayed in a variety of forms including animated progress indicators, numeric progress indicators, result summaries, graphs, and so forth. These and other testing features are known in the art, and may be suitably adapted to use with the systems and methods described herein.

Still more generally, the user interface 300 may support any functions useful in an advertising audit system. This includes, for example, editing tests, loading expected results, querying advertisers for intended advertising results, generating reports, scheduling tests, reviewing actual results or log files, and so forth. In one aspect, a visual presentation of a test may be provided, and visual or audible markers may be provided within the video showing test status, progress indicators (e.g., transitions between test scenarios) or flagging certain test results. As noted above, video archiving may preserve an audio-visual record of some or all of the test scenarios conducted by the system.

It will be appreciated that the various steps identified and described above may be varied, and that the order of steps may be changed to suit particular applications of the techniques disclosed herein, such as adaptations to different auditing needs or different client hardware and/or software. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. Further, the methods described herein may be supplemented in a number of ways, such as by using expert systems, neural networks, or other techniques for analyzes advertisement content and comparing expected results to actual results. Further, while a single process is depicted, it will be understood that the auditing systems described herein may be adapted to run a number of virtual client machines in parallel, and that each virtual client (as well as the auditing system monitoring operation thereof) may be deployed as any number of threads or other execution units suitable for a particular testing platform.

It will be appreciated that the above processes, and steps thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a number of computers and other devices, or all of the functionality may be integrated into a dedicated, standalone advertisement auditing system. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in a computer program product including computer executable code that, when executing on one or more computing devices, performs the steps thereof.

While the invention has been described in connection with certain preferred embodiments, other embodiments will be understood by those of ordinary skill in the art and are encompassed herein. As such, this disclosure is to be afforded the broadest interpretation allowable by law.

What is claimed is:

1. An advertisement auditing system comprising:
a network connecting to a plurality of advertising sources including at least one advertisement;
a client coupled to the network;
a controller that controls operation of the client to issue a request for the advertisement;
a monitor that monitors network activity of the client and compares the advertisement to an expected advertisement, thereby providing an audit result.

2. The advertisement auditing system of claim 1 further comprising a memory for storing the audit result.

3. The advertisement auditing system of claim 1 further comprising at least one advertising software program executing on the client.

4. The advertisement auditing system of claim 3 wherein the advertising software program includes one or more of spyware and adware.

5. The advertisement auditing system of claim 1 wherein the plurality of advertising sources includes at least one ad server.

6. The advertisement auditing system of claim 1 wherein the client is a virtual client maintained in a virtualization environment.

7. The advertisement auditing system of claim 1 further comprising a plurality of virtual clients in the virtualization environment, each of the plurality of virtual clients controlled by the controller.

8. The advertisement auditing system of claim 1 wherein the client is a physical device.

9. The advertisement auditing system of claim 8 wherein the controller is external to the client, the client including an agent for remote operation of the client by the controller.

10. The advertisement auditing system of claim 1 wherein the controller is adapted to prepare a report of audit results.

11. The advertisement auditing system of claim 10 wherein the controller transmits the report to a designated recipient by electronic mail.

12. The advertisement auditing system of claim 1 wherein the controller is adapted to capture screen shot information with audit results.

13. A method comprising:
operating a virtual client in a virtualization environment, wherein operating the network client includes directing the virtual client to engage in one or more interactions with a data network for which an expected advertisement should be transmitted to the virtual client;
identifying an advertisement actually received by the network client in response to the one or more interactions; and
comparing the advertisement with the expected advertisement to obtain an audit result.

14. The method of claim 13 further comprising operating a plurality of virtual clients in the virtualization environment.

15. The method of claim 13 further comprising repeatedly directing the virtual client through one or more test scenarios to provide continuous audit results.

16. The method of claim 13 further comprising executing at least one of a spyware program and an adware program on the virtual client.

17. A method comprising:
operating a virtual client in a virtualization environment, wherein operating the virtual client includes directing the virtual client to engage in one or more interactions with a data network for which an expected advertisement should be displayed on the virtual client;
identifying an advertisement actually displayed on the virtual client in response to the one or more interactions; and
comparing the advertisement with the expected advertisement to obtain an audit result.

18. The method of claim 17 further comprising operating a plurality of virtual clients in the virtualization environment.

19. The method of claim 17 further comprising repeatedly directing the virtual client through one or more test scenarios to provide continuous audit results.

20. The method of claim 17 further comprising:
directing the virtual client to engage in one or more interactions with the data network for which a second expected advertisement should be transmitted to the virtual client;
identifying a second advertisement actually received by the network client in response to the one or more interactions; and
comparing the second advertisement with the second expected advertisement to obtain a second audit result.
